(19) United States
(12) Patent Application Publication
(10) Pub. No.: US 2005/0246642 A1
(43) Pub. Date: Nov. 3, 2005

(54) Application for viewing video slide based presentations

(76) Inventors: Harold Michael Valderas, Austin, TX (US); Christopher Thomas Rebstock, Austin, TX (US)

Correspondence Address: LALLY & LALLY LLP, PO BOX 684749, AUSTIN, TX, 78768-4749, US

(21) Appl. No.: 11/121,193

(22) Filed: May 3, 2005

Related U.S. Application Data
(60) Provisional application No. 60/567,603, filed on May 3, 2004.

(51) Int. Cl. G06F 3/00

(52) U.S. Cl. 715/730; 715/840

(57) ABSTRACT

A computer program product includes instructions for playing back a video slide presentation comprised of navigable and linked video slides. The video slides include a looping video, text, and a set of navigation button objects. The product supports a variety of useability enhancements with instructions for: hiding the navigation buttons from view during playback, streaming the navigation signal to a remote system; copying the presentation to a favorites directory and creating a set of favorites links associated with the presentation; displaying a list of links associated with a presentation stored on a DVD as an alternative to adding the links to the favorites directory; editing the contents of an external file to alter the ordering of the video slides in the presentation; halting playback of a video slide until opening of a collateral document completes; and issuing a next navigation signal periodically during playback of the video slide presentation.

This application claims priority under 35 USC § 119(e) from provisional application No. 60/567,603 filed May 3, 2004, which is incorporated by reference in its entirety herein.

### RELATED APPLICATION

The subject matter disclosed in this application is related to the subject matter disclosed in U.S. patent application Ser. No. 11/069,710 entitled Video Slide Based Presentations filed Mar. 1, 2005 (referred to hereinafter as the Presentation Builder Application), which is incorporated by reference in its entirety herein.

### BACKGROUND

1. Field of the Present Invention

The invention is in the field of computer software and, more specifically, computer software for creating and viewing presentation graphics.

2. History of Related Art

Presentation applications such as POWERPOINT® from Microsoft are pervasive and well known. Presentation applications enable a user to create visually appealing business presentations based on a series of slides that may or may not include text. Each slide may be thought of as a graphical image. In the vast majority of cases, the images are static, with some limited ability to incorporate motion graphics on individual slides. While conventional presentation applications have served an extensive need for a considerable period of time, the slide-based paradigm of these applications has become antiquated. Simultaneously, in fields such as broadcast journalism, dynamic and stimulating graphics have become the standard and, in the field of consumer and entertainment electronics, multimedia technologies such as DVD have flourished.

Projections estimate the number of DVD players in use by 2006 at over 420 million, one third of which are projected to reside in personal computers. DVD is a versatile medium that can be played from personal computers, laptops, set-top players, or small portable DVD players. While DVD has emerged as a pervasive consumer/entertainment multimedia technology, developers have not attempted to provide business professionals with applications based on DVD or any other multimedia platform. Moreover, most businesses lack the multimedia tools, skills, and time necessary to incorporate multimedia technologies into their business communications. It would be desirable, therefore, to implement a software application that leverages the advanced audio and video capabilities of contemporary multimedia technologies to enable even unskilled users to build and present or display visually stimulating business presentations, kiosks, training and marketing materials.

### SUMMARY OF THE INVENTION

The objective identified above is achieved according to the present invention with a product for viewing video slide presentations such as the video slide presentations discussed in the Presentation Builder Application. A video slide is an object that preferably includes a looping background video, other still and/or motion video, an appended layer of text, and navigation button objects. The present invention enables even a novice user to present a video slide presentation. Important and innovative features implemented in embodiments of the present invention include support for hidden navigation buttons, an auto presenter utility, a save-to-external-format function, efficient file opening, an intelligent favorites menu, hot key support, and remote application linking.

The favorites menu differentiates the PVA from conventional applications on the market. The favorites menu serves as a management focal point of all of a user's presentations. Within the favorites menu, a user can access not only the video slide portions of each presentation, but also the documents associated with that presentation. The favorites menu features bring the video and supporting documents together in one interface, where both are easily accessible through a common drop down menu. In addition, when a DVD is added to the favorites, it is not only copied to the hard drive, but all the collateral documents are copied along with it, and links are made not only to the video slide presentation, but also to all the associated collateral documents. All of this media is automatically copied to the hard drive and organized in a directory that the user does not need to see or worry about.

Invisible navigation buttons refer to functionality that permits a presenter to turn off the navigation buttons that are a standard feature of interactive DVD videos and the DVD Power Tools Presentation Builder Application as disclosed in the Provisional Applicant and the Presentation Builder Application. The navigation buttons are still operable when they are hidden, but they are simply not visible to the viewing audience. The application is able to make the navigation buttons hidden because the buttons are mapped to keys that the user can press on their keyboard. In addition, if a user mouses over the buttons, or presses the up or down arrows, the buttons will again become visible.

The auto presenter feature facilitates automated presentations by, for example, causing the presentation to advance from one video slide to other at user-defined fixed intervals thereby making it possible to implement, for example, a loop kiosk. Auto presenter also offers the user control over the looping kiosk presentation by enabling the user to adjust the interval.

The save to external format feature of the present application enables a user to save a video slide presentation in a different format (preferably a presentation graphics format) such as a Microsoft® POWERPOINT® format. The feature saves a video slide presentation to the external format with the text stored as separately editable objects and the background as a template so that new slides can easily be added and existing slides can be edited. In addition, the save to external formation feature may include the ability to convert a presentation to a streaming format suitable for use in a distributed or networked environment.

Efficient file opening refers to the pausing of playback when the user selects to open an external document. Playback of the video slide resumes only when the user clicks play again. This feature improves the time required to open external files, because the processor is not preoccupied with maintaining the video playback.

The PVA also includes the ability to select any slide. In one embodiment, a the slide selection is made in a separate window that pops up to the right of the main window. This separate window enables the user to navigate directly to any slide by single clicking on a number representation of the slide. I will send a diagram of this to you so you can add it as well. This feature beneficially enables the ability to navigate to any slide in a presentation quickly and easily.

Remote application linking refers to the ability to coordinate presentations in a distributed manner by having one presentation serve as the master for a set of slave presentations that reside on remote machines. The master slave relationship preferably refers to the pushing of navigation signals from the master presenter to the slave presenters. The remote machines may already have the presentation content stored locally, in which case the master needs only to stream the navigation signals, thereby enabling it to operate in environments with limited bandwidth or excessive latency.

Another feature of the PVA is the Current DVD Menu. It works in a similar fashion to the favorites menu, except that it does not require the DVD to be copied to the hard drive. Instead, the menu button is clickable when a DVD is inserted. The application will automatically go through and add all items to the menu. These items include all collateral on the disk, such as documents as well as a link to the presentation.

The PVA application preferably also facilitates the rearranging of video slides using XML files. The PVA may also enable the user to add new slides or delete or edit existing slides.

The application preferably also includes versioning capabilities. If the user inserts a DVD that is a newer version of a DVD that is already stored on the hard drive, the application will prompt the user to copy the newer version to the hard drive, and automatically overwrite the old version and update the links in the favorites menu.

### BRIEF DESCRIPTION OF THE DRAWINGS

Other objects and advantages of the invention will become apparent upon reading the following detailed description and upon reference to the accompanying drawings in which:

FIG. 1 is a block diagram of a data processing system including a presentation viewer application according to an embodiment of the invention;

FIG. 2 is a flow diagram illustrating a program product (software) for viewing a video slide presentation;

FIG. 3 depicts a favorites management interface according to an embodiment of the present invention;

FIG. 4 is a conceptual depiction of hidden button functionality of the invention;

FIG. 5 is a flow diagram illustrating hidden button functionality according to an embodiment of the invention;

FIG. 6 is a flow diagram depicting an auto presenter feature of the present invention;

FIG. 7 depicts save to external format functionality according to the present invention;

FIG. 8 depicts a main menu user interface according to an embodiment of the present invention;

FIG. 9 depicts remote linking according to an embodiment of the invention;

FIG. 10 depicts a current DVD drop down menu according to an embodiment of the invention;

FIG. 11 depicts an efficient file opening feature of an embodiment of the present invention; and

FIG. 12 illustrates a go to function according to the present invention;

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention encompasses a system, method, and software for presenting or viewing video slide based presentations such as the type of presentations that are created using the Presentation Builder Application. The software embodiment of the invention is referred to herein as the Presentation Viewer Application (PVA). The PVA enables a user to select and present a video slide presentation residing on a DVD, a disk, a streaming video or another suitable storage medium. In addition to its ability to playback video slide based presentations, the PVA provides extensive support for organizing and managing one or more presentations. This support includes a favorites menu that automatically creates links to the various elements of a presentation. When a user adds a presentation to the favorites menu, the presentation is copied to the system hard drive and the application creates a corresponding subdirectory within the favorites folder. The subdirectory preferably includes links to the presentation itself as well as links to any collateral pages or related documents needed for the presentation. Many other additional features of the application are described in greater detail below.

The PVA is suitable for use in playing back presentations including video slide-based presentations. For purposes of this disclosure, a video slide includes a relatively short video segment, usually less than approximately one minute in length, that loops seamlessly and endlessly. The video slide includes a moving background over which text and possibly other graphics are displayed. The text and other graphics are preferably included in the video slide as an overlay to the video-based looping background. A video slide may display its associated navigation elements or, alternatively, the user may elect to hide them from display.

Although the PVA is not limited to any particular video format or storage format, an embodiment of the PVA is suitable for use with DVD-compatible presentations that use MPEG compliant video slides. DVD-compatible embodiments of the invention operate on presentations that may be stored on a DVD and played on a conventional DVD player. Alternatively, the presentation may be stored to a hard disk of a computer. The PVA may then play the image directly from the hard disk.

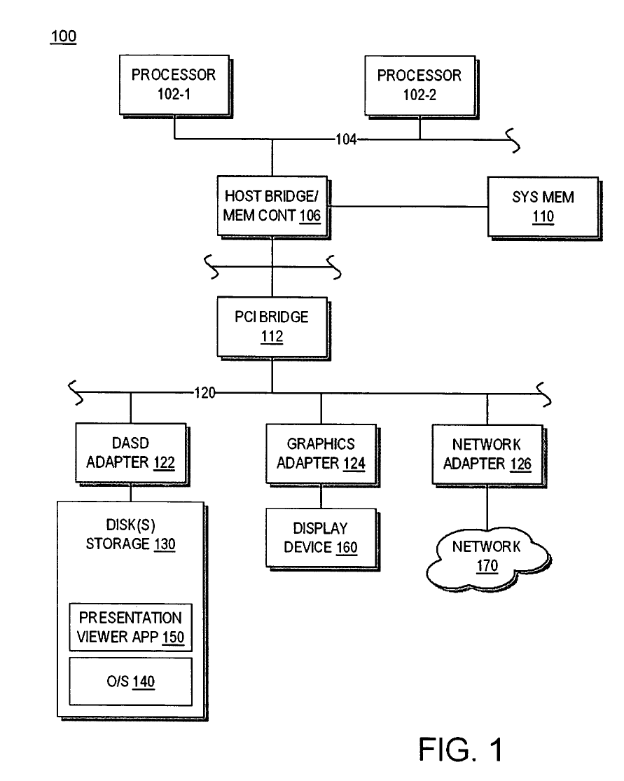

Turning now to the drawings, FIG. 1 is a block diagram of selected elements of an embodiment of a data processing system 100 suitable for implementing the PVA to view or present to others video slide based presentations. In the depicted embodiment, system 100 includes one or more general purpose microprocessors, two of which are shown as processors 102-1 and 102-2 (generically or collectively referred to herein as processor(s) 102). Processors 102 are connected to a shared bus 104 referred to herein as host bus 104. A host bus bridge (host bridge) and memory controller 106 provides an interface between system bus 104 and a system memory 110 thereby enabling processors 102 to access system memory 110. System 100 is referred to as a symmetric multiprocessor system because each processor 102 has equal access to system memory 110 (e.g., the latency for an access to system memory 110 is approximately the same for all processors 102). Other implementations of system 100 include single processor systems and non-uniform memory architecture multiprocessor systems.

System 100 as shown includes a PCI bridge 112 providing an interface between host bridge 106 and a PCI bus 120. PCI (peripheral components interface) is an industry connectivity standard. Other implementations of system 100 may use other connectivity protocols including the Infiniband protocol.

In the depicted configuration, system 100 includes a direct access storage device (DASD) adapter 122, a graphics adapter 124, and a network adapter 126 connected to PCI bus 120. DASD adapter 122 controls disk storage (hard disk) 130. Graphics adapter 124 provides the control for a display device 160 (e.g., a CRT or LCD). Network adapter 126 provides connectivity between system 100 and an external network 170. Network 170 may include a local area network (LAN) and/or a wide area network such as the Internet.

In the depicted embodiment, data processing system 100 includes computer program code stored in its hard disk 130. The computer program code includes an operating system 140 and a presentation viewer application (PVA) 150 according to the present invention. The present invention is not limited to a particular operating system. Accordingly, operating system 140 may be a Windows® family operating system from Microsoft Corporation, a Unix or Unix derivative operating system, a Linux operating system.

PVA 150 provides the computer code that, when executed, enables a user to playback (view) video-slide based presentations. As such, portions of the invention are implemented as a set or sequence of computer executable code stored on a computer readable medium such as hard disk 130. During times when the code is being executed by a processor 102, portions of the code may be stored in system memory 110 or in one or more cache memories (not illustrated) associated with processor(s) 102.

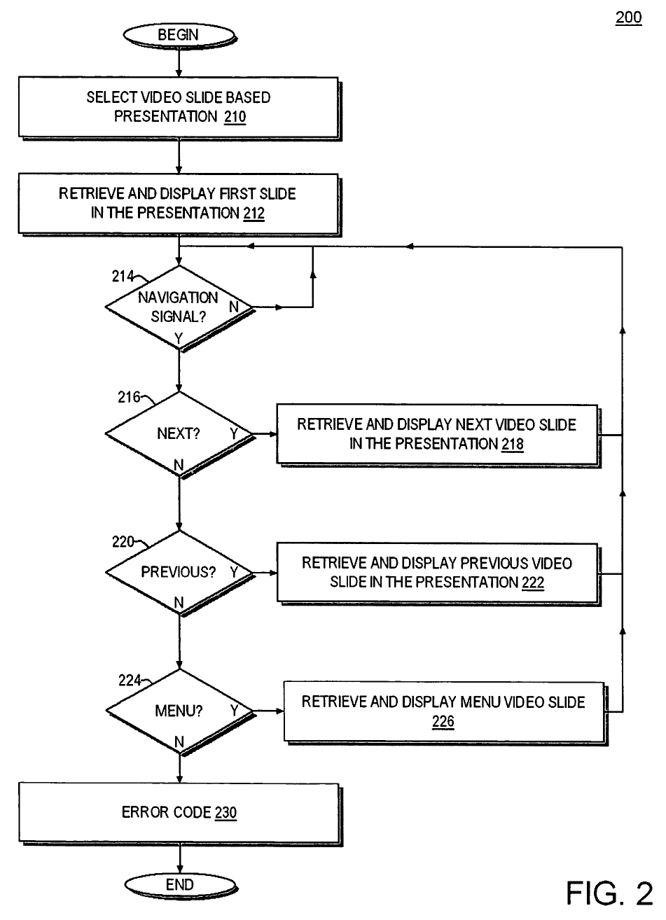

Referring now to FIG. 2, a flow diagram conceptually depicts selected elements of a method 200 of presenting a video slide based presentation according to an embodiment of PVA 150. Method 200 emphasizes the basic play back functionality of PVA 150. Other features of PVA 150 are described in greater detail with respect to FIG. 2 through FIG. 10.

In the depicted embodiment of method 200, a user of PVA 150 selects (block 210) a video slide based presentation for viewing. As described in the PRESENTATION BUILDER APPLICATION, a video slide presentation according to the present invention is a navigable and linked set of video slides. The video slides are characterized by a looping video background, text, and a set of navigation button objects including a next button, a previous button, and a menu button.

As described in greater detail below, the user may select a presentation from the “current” DVD (i.e., the DVD currently residing in a DVD drive of a computer system on which PVA 150 is executing). Alternatively, the user may select a presentation from the persistent storage (hard disk) of the computer system through a “favorites” menu or using a file/open command sequence.

In response to the user's selection of a presentation, PVA 150 retrieves (block 212) and displays the first slide in the presentation. The first slide in a typical video slide based presentation is a main menu slide as described in the PRESENTATION BUILDER APPLICATION, but the first slide may be a video slide or a movie slide as well. The first slide generally includes a one or more navigation buttons. The navigation buttons may include a next button, a previous button, and a menu button that enable the user to navigate through the slides in a presentation sequentially or to navigate back to the main menu from any slide in the menu as described in the PRESENTATION BUILDER APPLICATION.

PVA 150 plays the current slide while monitoring (block 214) for a navigation signal. The depicted embodiment of PVA 150 emphasizes implementations having three basic navigation signals, the next signal, the previous signal, and the menu signal. Upon detecting a navigation signal, PVA 150 determines the navigation signal type and takes appropriate action in response thereto. If PVA 150 determines (block 216) that the detected navigation signal is a next signal, PVA 150 retrieves and displays (block 218) the next slide in the presentation. Similarly, if PVA 150 determines (block 220) that the navigation signal is a previous signal, PVA 150 retrieves and displays (block 222) the previous slide. Finally, if PVA 150 determines (block 224) that the detected navigation signal is a menu signal, PVA 150 retrieves and displays (block 226) the main menu slide of the presentation. If PVA 150 does not recognize the navigation signal, it issues (block 230) an error code.

In one embodiment referred to as a user-led presentation, the navigation signals are generated by the user. The user may generate the navigation signals by “clicking” on the navigation buttons that may be visible on the slides in the presentation. Alternatively, the navigation signals may be generated when the user activates a key on a conventional keyboard or on a remote control device. In these instances, the keyboard or remote key activated by the user may be mapped to one of the navigation buttons so that, for example, typing the “enter” key generates a next navigation signal, typing a back arrow key generates a previous navigation signal, and typing the escape key generates a menu navigation signal. Regardless of how the navigation signals are generated, PVA 150 responds to the signals by retrieving and display the appropriate slide.

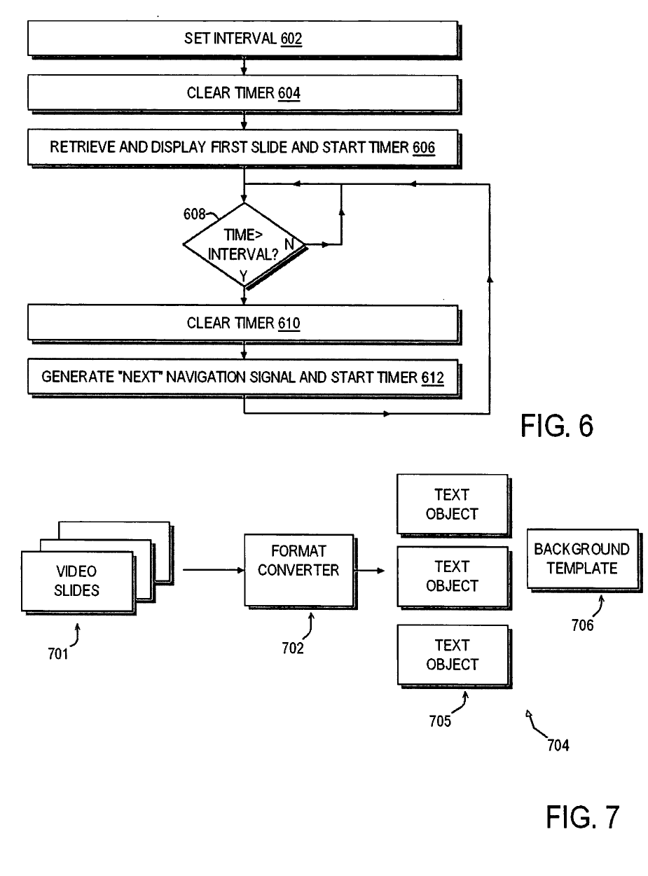

PVA 150 may also be operated in an auto-presenter mode in which the application itself generates a navigation signal periodically. In this mode, PVA 150 generates a next navigation signal at user-specified intervals. Auto presenter mode is suitable for applications in which a presenter is not necessary or desirable. As an example, the auto presenter mode is appropriate for exhibiting a series of slides continuously, such as in conjunction with an exhibit at a tradeshow. An embodiment of auto presenter mode is depicted conceptually in FIG. 6. In this implementation, an interval is set (block 602) by the user. PVA 150 then clears (block 604) a variable referred to as “timer,” which is capable of implementing a timing feature. PVA 150 then retrieves and displays (block 606) the first slide in a selected presentation while starting the timer variable. PVA 150 then loops while playing the current slide (the first slide) until (block 608) the timer value exceeds the predetermined interval. When the timer variable exceeds the interval value, the timer is then cleared (block 610) and a “next” navigation signal is issued (block 612).

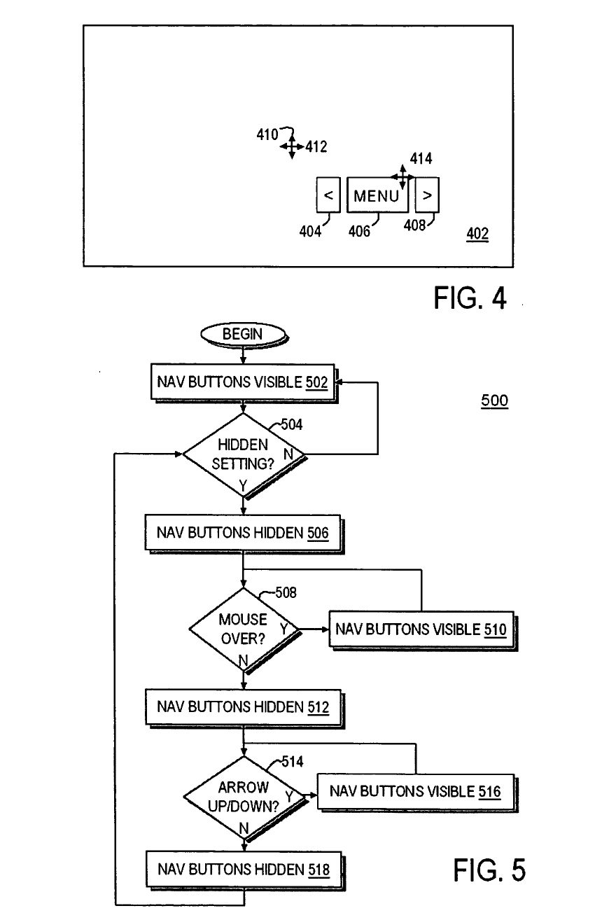

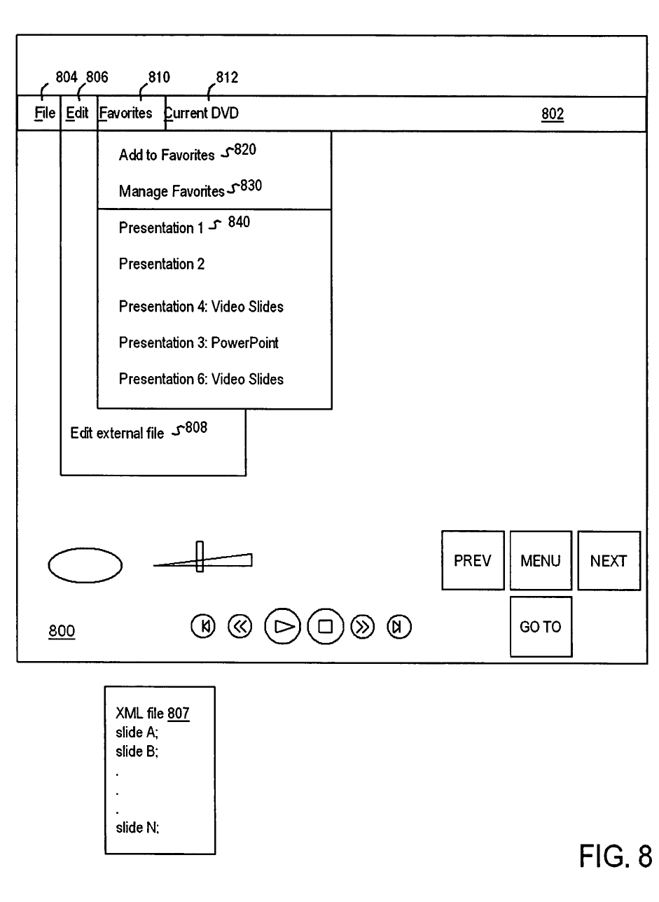

In one embodiment, PVA 150 includes one or more graphic user interfaces (GUI's) that facilitate user interaction with the application's features and capabilities. An exemplary “main menu” GUI 800 is depicted in FIG. 8. In the depicted embodiment, GUI 800 of PVA 150 includes a menu bar 802 that includes a File menu 804, an Edit menu 806, a Favorites menu 810, and a Current DVD menu 812. File menu 804, when selected, displays file commands such as an “open” command enabling the user to open a presentation from disk. File menu 804 might also include commands controlling settings of PVA 150. One such PVA setting is a hide button setting. When the user selects the hide button setting under file menu 804, PVA 150 turns of the display of the video slide navigation buttons so that the buttons do not distract the viewers or detract from the image being displayed. The hide button functionality of PVA 150 according to one implementation is conceptually depicted in FIG. 4 and FIG. 5. FIG. 4 represents an exemplary presentation slide 402, which can be a video slide, a menu slide, or even a movie slide. Presentation slide 402 includes navigation buttons 404, 406, and 408. In addition, FIG. 4 depicts a cursor 410 that may be controlled by a user of PVA 150. Upon activating the hide button function, PVA 150 hides navigation buttons 404, 406, and 408 so that they are not visible to a viewer of the presentation. If, however, the user “mouses” cursor 410 from a position such as position 412, where the cursor 410 is not over the navigation button position, to a position 414, where the cursor is over the navigation button positions, navigation buttons 404, 406, and 408 are made temporarily visible.

The hide button functionality according to one implementation is represented in the flow diagram 500 of FIG. 5. In this implementation, the hide navigation button feature is implemented with a type of toggle switch. Initially, as depicted in block 502, the navigation buttons are visible when a presentation is played back. PVA 150 then determines (block 504) whether the user has activated the hide button functionality. PVA 150 may monitor this feature by periodically polling a variable associated with the hide button feature or, more likely, by generating an interrupt when the feature is selected by a user.

Upon determining that the user has activated the hide button feature, PVA 150 sets (block 506) the navigation buttons to hidden. Making the navigation buttons hidden is facilitated, in one embodiment, by implementing the navigation buttons on a dedicated “layer” of the presentation so that the buttons may be manipulated with little overhead.

In the embodiment depicted in FIG. 5, making the navigation buttons hidden in block 506 does not render the buttons non-functional. Specifically, PVA 150 monitors (block 508) for a mouse over event in which the cursor is positioned over the hidden navigation buttons. While the cursor is so positioned, the navigation buttons are made visible (block 510) temporarily. During the time when the buttons are visible, they are also functional so that the user may click on one of the temporarily visible buttons to activate its function. After the cursor is no longer positioned over the navigation button positions, the navigation buttons return (block 512) to hidden.

In addition, one or more keyboard or remote control keys or buttons may also temporarily make the otherwise hidden navigation buttons visible. In the embodiment depicted in FIG. 5, for example, the up and down arrow keys are used to control visibility of hidden navigation buttons. If activation of the up or down arrows buttons is detected (block 514), the navigation buttons are made visible (block 516). FIG. 5 shows the navigation buttons returning to hidden (block 518) following activation of the appropriate keyboard key. For example, the up arrow key may make hidden navigation buttons visible and the down arrow button returns the buttons to hidden. FIG. 5 also shows a path from block 518 to block 504 where PVA 150 determines the status of the hidden/visible setting to emphasize that PVA 150 is continuously monitoring for the hidden button function and that the hidden button function may be activated at any time.

One embodiment of PVA 150 supports hot key functions. A hot key is a keypad key or other suitable key that is associated with a particular presentation or a particular portion of a presentation. When the hot key is activated from within the viewer application, PVA 150 jumps from its current location in a presentation to the portion of a presentation that is associated with PVA 150. In one embodiment, hot key programming is achieved by pressing and holding a key for a specified duration. After the duration has passed, the key is associated with the location.

Returning to FIG. 8, the edit menu 806 of main GUI 800 may include video options settings for PVA 150 such as interleaved versus weaved video. Edit menu 806 may also include at least some facilities for editing the content of a presentation. For example, PVA 150 may support the ability to rearrange to ordering of presentation slides. In some embodiments, the slide ordering is determined by the content of an “external” file such as an XML file 807. In such embodiments, edit menu 806 may include a command 808 to retrieve and edit the contents of the XML file 807 and thereby edit the ordering of the video slides in the presentation.

FIG. 8 depicts a favorites menu 810 in its “dropped down” state. PVA 150 includes a favorites function the provides focal point for the management of one or more presentations. Video slide presentations suitable for use with PVA 150 may include, in addition to a large number of video-based slides, one or more “collateral” documents. These documents may include, as examples, spreadsheet documents, PDF documents, word processing documents, and the like. The favorites menu functionality in the preferred embodiment of PVA 150 provides a centralized facility in which all of the different types of documents associated with a presentation may be managed.

The dropped down favorites menu 810 depicted in FIG. 8 includes an Add to Favorites command 820 and a Manage Favorites command 830. When a presentation has been opened with the File menu 804, Add to Favorites makes a copy of the presentation that is stored on disk in a directory associated with the Favorites function (a Favorites directory). In addition, when a presentation is added to the favorites, PVA 150 creates links to the various elements of the presentation (e.g., the video slides, the collateral documents, etc.). Drop down menu 810 also includes links 840 to the favorite presentations or portions of presentations that have been previously added to the Favorites function. In the depicted example, the links include links to entire presentations (Presentation 1 and Presentation 2) as well as links to specific portions of some presentations (e.g., the video slides of presentation 4).

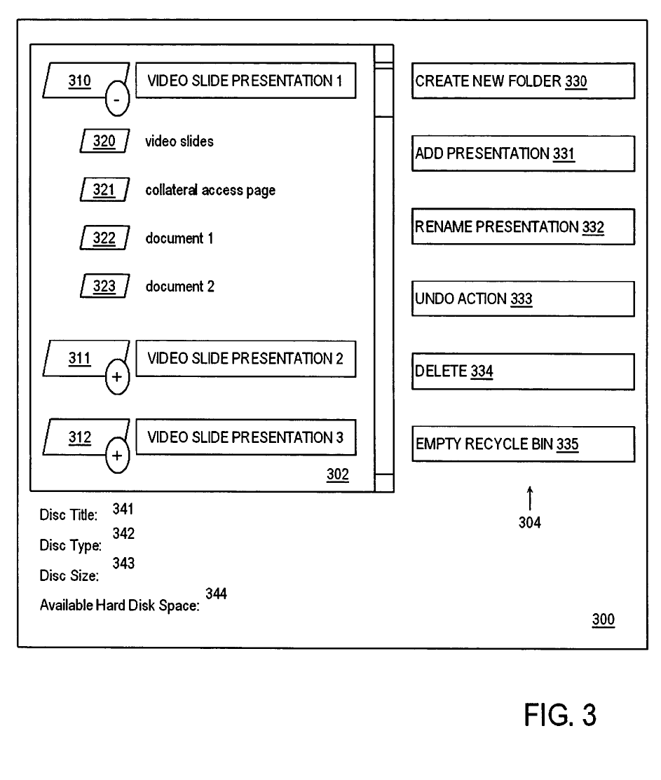

Referring also now to FIG. 3, an exemplary Favorites Manager GUI 300 is depicted. GUI 300 is displayed when the user clicks on the Manage Favorites command 830 of GUI 800. Favorites manager GUI 300 includes a favorites directory window 302 and a command list 304. Favorites directory window 302 includes an expandable list of presentations that have been added to the favorites directory. Each favorites presentation is represented by a folder in window 302. The depicted illustration of window 302 includes presentation folders 310, 311, and 312. Presentation folder 310 has been expanded to reveal links 320 through 323 where each link corresponds to a different portion of presentation 310. In the depicted embodiment, for example, presentation folder 310 includes links to the presentation's video slides (320), collateral documents (321), and a pair of word processing, PDF, or other types of documents (322, 323). The folders 310 through 312 are expandable and collapsible in a conventional way to improve the readability of directory window 302

The command list 304 includes the commands to create new folders (330) in directory window 302, add a presentation (331) to the favorites directory, and rename a presentation (332). In addition, the depicted embodiment of command list 304 includes the ability to undo the previously entered action (333), which is analogous to the undo function common to word processing applications. Menu list 304 also includes a delete function 334 and an empty recycle bin 335 with which a user may eliminate presentations from the favorites directory. Delete command 334 in this case may only cause a presentation to be moved to a “trash” bin and it is not until the user empties the trash with command 335 that the presentation is deleted from the favorites directory on the hard drive.

In addition to the features described above, the depicted implementation of favorites GUI 300 includes indicators including an indicator 341 of the title of any DVD that is inserted in the DVD drive, an indicator 342 of the disc type, an indicator 343 of the disc storage capacity, and an indicator 344 of the available space on the hard drive.

The favorites functionality of PVA 150 may also include a versioning feature in which PVA 150 determines that a presentation on a DVD that it is inserted in the DVD drive is a different version of a presentation that is also resident in the favorites directory. In this case, PVA 150 may update the favorites directory by replacing the version of the presentation stored in the favorites directory with the version stored on the DVD.

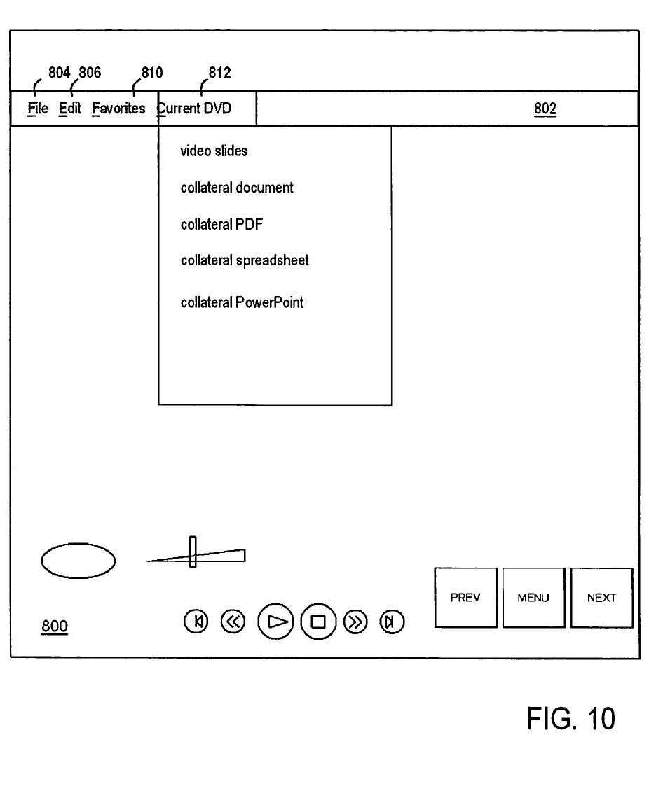

Returning to FIG. 8, GUI 800 is shown as including a Current DVD menu 812. Current DVD menu 812, when selected presents a drop down list that enumerates the elements of the presentation that is resident on the DVD. Current DVD menu 812 provides directory-like access to the elements of a presentation analogous to the manner in which Favorites menu 810 presents a directory of elements for presentations that have been added to the favorites. Recognizing that many presentations may require significant disk storage space, current DVD menu 812 provides a useful tool for viewing the elements of a presentation without storing the entire presentation to disk. An exemplary Current DVD menu 812 is shown in FIG. 10 as including links to the current presentation's video slides, collateral documents, PDFs, spreadsheets, and the like.

In one embodiment, the file command 804 of GUI 800 includes a function that saves a presentation to an “external” format. In one embodiment of particular significance within presentation graphics domain, a “save to” function saves a presentation in a format that is compatible with POWERPOINT® from Microsoft Corporation. Referring to FIG. 7, some embodiments of PVA 150 include format converter functionality represented by reference numeral 702. Converter 702 is configured to generate a POWERPOINT® compatible presentation from a set of video slides 701. In one implementation of the converter functionality, the POWERPOINT® compatible presentation 704 generated from the video slides 701 includes a set of separately editable text objects 705 and a template 706 derived from the background of the looping video. In this embodiment, converter 702 extracts text from each slide 701 and also creates a background slide derived the motion video background of the video slides 701 (e.g., a snapshot of the motion video background). This embodiment is desirable for applications in which additional new slides may be required. By separating the text from the background elements, the converter function 702 generates a POWERPOINT® presentation from which additional slides may be easily generated.

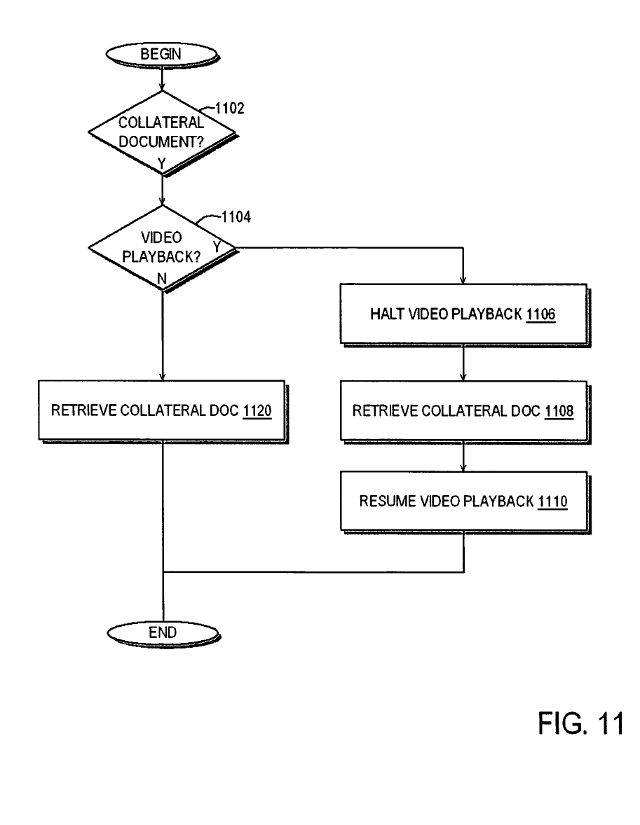

PVA 150 may also include useability enhancements including an efficient file opening feature and a “go to” feature. Efficient file opening refers to a feature of PVA 150 that halts video playback while collateral files are being opened. Flicker-free video playback requires a steady stream of data being supplied to the application. When a collateral file is first opened the processor may have insufficient capacity to service the data retrieval request without having a negative effect (e.g., flicker) on the video playback. PVA 150 recognizes this reality and incorporates intelligence to halt video playback while collateral documents such as PDF documents, spreadsheet documents, and the like are being opened. One implementation of efficient file opening functionality is illustrated in FIG. 11. In this implementation, PVA 150 monitors for and detects (block 1102) a user request for a collateral document. Upon receiving a collateral document request, PVA 150 then determines (block 1104) whether playback of any video or multimedia content is in progress. If video content is in progress, PVA 150 halts (block 1106) video playback before retrieving (block 1108) the requested collateral document. Following retrieval of the collateral document, PVA 150 then resumes (block 1110) playback of the video content. If PVA 150 is not playing back video content when the collateral document request is processed, PVA 150 simply retrieves (block 1120) the requested document. Efficient file opening beneficially reduces or prevents loss of video playback quality during times when collateral documents are being requested and processed.

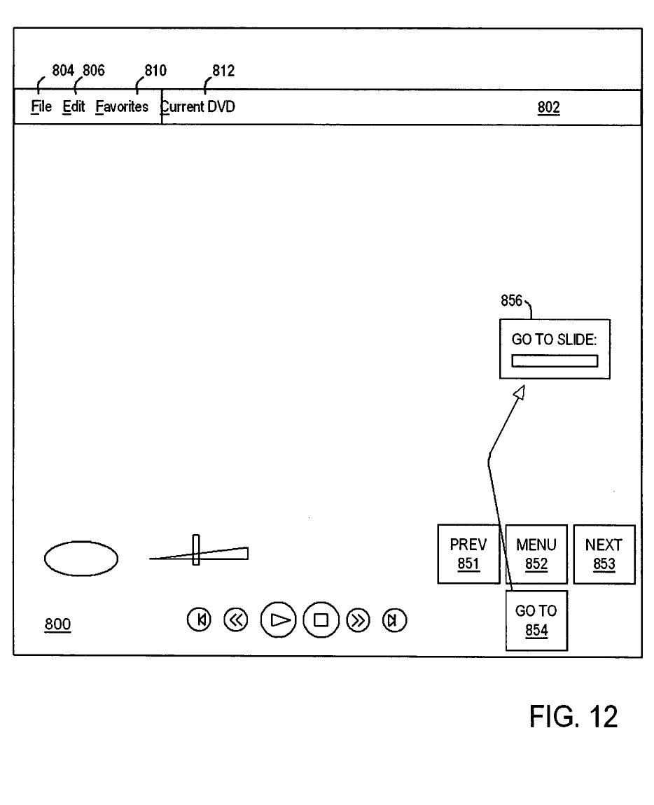

The go to feature is implemented in at least some embodiments of PVA 150. As suggested by its name, the go to feature enables a user to direct the presentation to any of its video slides from any other slide in the presentation. This functionality is available during playback of the presentation as opposed to conventional presentation graphics applications in which the “go to” feature is typically available only in the context of presentation editing. The go to feature eliminates the need to page through consecutive video slides one-by-one to get at the desired interior slide. An implementation of the go to feature is depicted in FIG. 12. In FIG. 12, the PVA main menu (described above with respect to FIG. 8) now includes a navigation button in addition to the next, menu, and previous buttons 851 through 853. Specifically, GUI 800 as implemented in FIG. 12, includes a go to button 854. Go to button 854 may be activated during playback of a presentation to enable the presenter to transition quickly to a video slide that is not adjacent to the currently displayed slide. In the embodiment depicted in FIG. 12, activating go to button 854 generates a popup style window 856 to appear. The window 856 prompts the user to enter an indicator of the selected video slide such as a number of the video slide that the user wishes to view.

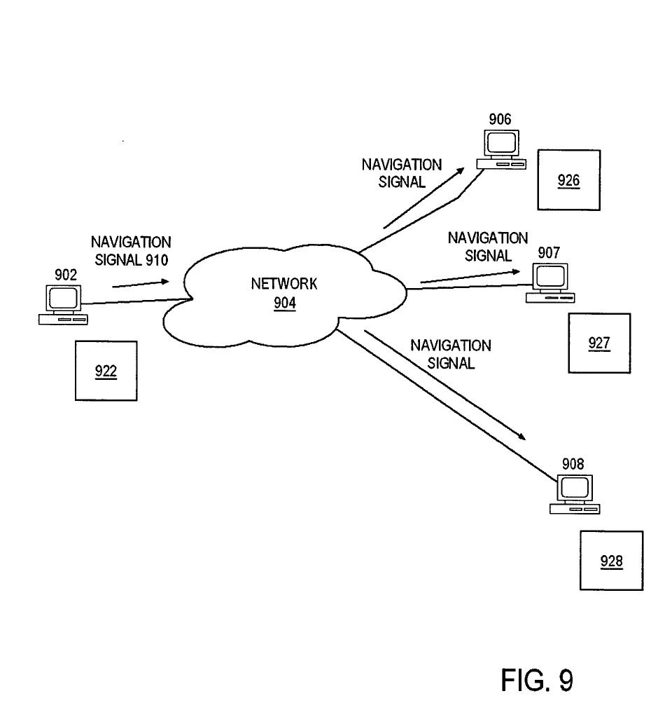

Referring now to FIG. 9, a remote linking feature implemented on some embodiments of PVA 150 is illustrated. In the depicted implementation, a master user is represented by master data processing system (computer) 902 and a set of slaves are represented by systems 906 through 908. A copy of video slide presentation is local to each of the systems. For example, master computer 902 has a copy 922 of a video slide presentation, slave computer 906 has a local copy 926 of the presentation, and so forth. In this implementation, it is only necessary for master computer 902 to stream navigation signals 910 to the other computers because the presentation content is locally stored in each system 906 through 908. Using this technique, master 902 is able to control the presentation to multiple viewers located on across a diverse network and potentially wide area network. In other embodiments, local copies of the presentation are not stored locally. In such embodiments, master 902 must transmit or stream the multimedia content, in addition to the navigation signals, across the network. The remote presentation features depicted in FIG. 9 may be used in conjunction with the auto presenter features to implement multiple instances of looping kiosks.

It will be apparent to those skilled in the art having the benefit of this disclosure that the present invention contemplates a system, method, and software for presenting video-based presentations. It is understood that the form of the invention shown and described in the detailed description and the drawings are to be taken merely as presently preferred examples. It is intended that the following claims be interpreted broadly to embrace all the variations of the preferred embodiments disclosed.

1. A computer program product comprising computer executable instructions, stored on a computer readable medium, for playing back a video slide presentation, the instructions comprising:
instructions for playing a first video slide in a navigable and linked set of video slides, wherein the first video slide includes a looping video, text, and a set of navigation button objects;
instructions for responding to a navigation signal received while displaying the first video slide by displaying a second video slide;
wherein the navigation signal is selected from a group of navigation signals including a next slide signal for displaying a sequentially next slide, a previous video slide signal for displaying a sequentially previous video slide, and a menu signal for displaying a menu slide.

2. The computer program product of claim 1, further comprising instructions for hiding from view during said playing, the set of navigation button objects.

3. The computer program product of claim 1, instructions for displaying hidden navigation buttons in response to a pointing device moving over the location of the navigation button objects.

4. The computer program product of claim 1, further comprising instructions for streaming the navigation signal to a remote system wherein the remote system is configured to respond to the navigation signal by displaying the second video based slide on the remote system.

5. The computer program product of claim 1, further comprising:
instructions, responsive to a user adding the video slide presentation to a favorites directory, for copying the presentation to the favorites directory and creating a set of favorites links associated with the presentation; and
instructions for displaying the set of favorites links associated with the presentation responsive to the user displaying the favorites directory.

6. The computer program product of claim 5, wherein the instructions for creating a set of favorites links comprises instructions for creating a favorite link associated with a video slide portion of the presentation and at least one link associated with a collateral document portion of the presentation.

7. The computer program product of claim 6, further comprising instructions for managing the favorites directory including instructions for displaying the favorites directory as a group of expandable folders, each folder corresponding to a presentation, and for displaying the favorites links associated with a folder by expanding the folder.

8. The computer program product of claim 5, further comprising instructions, responsive to a user opening a second version of presentation wherein a first version of the presentation is stored in the favorites directory for updating the favorites directory with the second version of the presentation.

9. The computer program product of claim 5, further comprising instructions for displaying a list of links associated with a presentation stored on a DVD as an alternative to adding the links to the favorites menu.

10. The computer program product of claim 1, further comprising instructions for editing the contents of an external file to alter the ordering of the video slides in the presentation.

11. The computer program product of claim 10, wherein the external file comprises an XML file.

12. The computer program product of claim 1, further comprising instructions, responsive to a user opening a collateral document associated with the video slide presentation, for halting play back of a video slide until opening of the collateral document completes.

13. The computer program product of claim 1, further comprising instructions enabling a user to enter an indicator of a selected slide during play back of the presentation and instructions for responding to said entering by displaying the selected slide.

14. The computer program product of claim 1, further comprising instructions for storing the video slide presentation to an external format.

15. The computer program product of claim 14, wherein the instructions for storing the video slide presentation to an external formation comprise instructions for storing text in the video slide presentation as a set of editable text objects and instructions for storing a template derived from a looping video background of a video slide in the video slide presentation.

16. The computer program product of claim 1, further comprising instructions for issuing a next navigation signal at user specified fixed intervals during playback of the video slide presentation.

17. The computer program product of claim 1, further comprising instructions for setting a hot key correspondence between a keypad key and a portion of the video slide presentation including a collateral document associated with the presentation and instructions for responding to subsequent activation of the keypad key by displaying the corresponding portion of the video slide presentation.

18. A data processing system including a processor and storage, the storage containing instructions executable by the processor, the instructions comprising:
instructions for playing a first video slide in a navigable and linked set of video slides, wherein the first video slide includes a looping video, text, and a set of navigation button objects;
instructions for responding to a navigation signal received while displaying the first video slide by displaying a second video slide;
wherein the navigation signal is selected from a group of navigation signals including a next slide signal for displaying a sequentially next slide, a previous video slide signal for displaying a sequentially previous video slide, and a menu signal for displaying a menu slide.

19. A computer program product comprising computer executable instructions stored on a computer readable medium, for viewing a video slide presentation, comprising:
instructions for responding to playback navigation signals including a next slide signal, a previous slide signal, and a menu signal, by displaying a slide in the video slide presentation indicated by the navigation signal;
instructions for adding the presentation to a favorites directory including instructions for copying the presentation to the favorites directory, instructions for creating a subdirectory corresponding to the presentation in the favorites directory and instructions for creating links under the subdirectory to different elements of the presentation including a video slide element and a collateral document element; and
instructions for accessing a component of the presentation by selecting the corresponding link in the favorites directory.

20. The computer program product of claim 19, wherein the video slide presentation includes a video slide comprising a looping video, an appended text layer, and a set of navigation objects, wherein the computer program product further includes instructions for hiding the navigation buttons during playback.
